(19) United States
(12) Patent Application Publication
(10) Pub. No.: US 2005/0092666 A1
(43) Pub. Date: May 5, 2005

(54) Dialysis cartridge

(76) Inventor: John R. Wilson, New Brighton, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/982,711

(22) Filed: Nov. 4, 2004

Related U.S. Application Data
(60) Provisional application No. 60/517,208, filed on Nov. 4, 2003.

(51) Int. Cl. B01D 35/14

(52) U.S. Cl. 210/136; 210/321.6; 422/101; 210/450

(57) ABSTRACT

An easy to use device for the dialysis of a sample. The device embodies a liquid tight compartment, a portion of which is a membrane capable of allowing molecules and compounds of a pre-determined size to pass into and out of the compartment. The cartridge can be fabricated in a manner that provides a highly efficient surface area to volume ratio between the membrane and the sample, allows the use of standard laboratory pipettes for sample introduction and removal, is automatically oriented in a beneficial position when residing in dialysate solution, and prevents the potential for damage to the membrane from osmotic imbalance between the sample and the dialysate.

### RELATED APPLICATION

The present application claims the benefit of U.S. Provisional Application No. 60/517,208 filed Nov. 4, 2003, which is incorporated herein in its entirety by reference.

### FIELD OF THE INVENTION

The present invention relates to a device for the dialysis of small samples such as those commonly dialyzed in research laboratories. The device can interface with standard laboratory pipettes for the introduction and removal of samples, integrate a high ratio of dialysis membrane surface area to sample volume size for improved mass transfer, automatically orient in a beneficial position when residing in dialysate solution, and prevent the potential for damage to the dialysis membrane from osmotic imbalance between the sample and the dialysate.

### BACKGROUND

Dialysis of samples to alter the molecular composition is a routine laboratory practice. Placing the sample in a container that is comprised of a dialysis membrane, and immersing the container in a dialysate solution allows control over the final composition of the solution. Two styles of products dominate the market. The first style consists of dialysis tubing, such as that marketed by Spectrum Labs. The second style is a cartridge format marketed by Pierce Chemical under the trade name Slide-A-Lyzer®.

Historically, the use of tubes of dialysis membrane has been the most common method of dialyzing samples. Even though it is a traditional method of dialyzing samples, dialysis tubing has substantial shortcomings. The shortcomings include a poor membrane surface area to sample volume ratio, the need for users to make liquid tight seals, and loss of control over the location of the tubing within the dialysate.

Since dialysis tubing takes the shape of a cylinder when filled with a sample, the inherent geometry leads to a poor rate of mass transfer. This leads to delayed sample dialysis time. Another drawback of using dialysis tubing is related to its method of fabrication. It is extruded, resulting in a continuous length of tubing that is provided in a roll format to the customer. The customer then cuts any given length of tubing needed to hold the sample. Prior to placing the sample in the tube, one end of the tube must be sealed by either tying it or clamping it. Then, the sample is dispensed into the tube, at which point the other end must be tied or clamped to form a liquid tight seal. The fact that the tubing is flimsy, particularly when wet, makes it difficult to perform the sealing operation. Loss of sample can occur during this step from spillage, or leaking if the seal is not liquid tight. At this point, the tube is placed in a container full of dialysate. Often, a stir bar mixes the dialysate in order to accelerate mass transfer. If the tube sinks to the bottom of the container, it can be hit by the spinning stir bar and break open, resulting in loss of the valuable sample.

Attempts to improve the dialysis tube approach are described in U.S. Pat. No. 5,324,428 and U.S. Pat. No. 5,783,075. These patents teach how to eliminate the need for users to make the initial seal, and simplify the process of making the final seal. Additionally, the tube is oriented within the dialysate solution in a manner that minimizes risk of damage by the spinner bar. Unfortunately, a great deal of manufacturing complexity is added to achieve this objective. Most importantly, no improvement to the poor surface area to volume ratio is made.

U.S. Pat. No. 5,503,741 discloses an alternative configuration that addresses many of the shortcomings of dialysis tubing. Two main attributes are improvements over the dialysis tube. First, improved surface area to volume ratio is attained because the dialysis cartridge is rectangular instead of cylindrical. Second, liquid tight seals are formed automatically. The configuration is commercially available from Pierce Chemical under the trade name Slide-A-Lyzer®. However, the improvements come at the cost of eliminating the ability to use standard laboratory pipettes as a tool to access the sample compartment. Needles must be used, and in a manner that increases the possibility of a needle puncture to the operator and needle damage to the dialysis membranes. The sample must be introduced and removed from the dialysis cartridge by inserting a needle through an elastomeric gasket in a way that orients the needle parallel to the dialysis membranes of the device. This orientation requires a user to place one hand on the dialysis cartridge to hold it steady, as the other hand drives the needle into the dialysis cartridge. Thus, the needle is pointed at one of the users hands as it is pushed by the other hand to drive it further in that direction. This enhances the possibility of a needle stick. Even if the needle does not slip out of place and render injury to the user, it can easily damage the dialysis membrane. As it passes through the gasket, it is in proximity of the thin dialysis membrane. Even a slight deviation from parallel as the needle emerges from the gasket can cause the needle to puncture the very thin dialysis membrane. This problem is compounded because the needle has a tendency to accelerate as it exits the gasket due to the substantial reduction in resistance at that point, making it hard to control the needle. When removing a sample, the dialysis membrane is wet and has a tendency to sag, orienting it directly in the path of needle travel. Since the samples being dialyzed can be very expensive, and loss to puncture of the dialysis membrane is quite possible, this design flaw is a very detrimental characteristic of the apparatus.

Another problem with the requirement of inserting a needle through a gasket to deliver and remove the sample is that it limits any further reduction in surface area to volume ratio because the gasket must be of a minimum thickness so that a needle can penetrate it. Therefore, reducing the thickness of the dialysis cartridge is limited by the needle diameter. Another drawback is that there is no provision for preventing the device from sinking in the dialysate and potentially making contact with a spinner bar. In practice, a second product that acts as a floatation device must be purchased and attached to the dialysis cartridge in order to address this problem. Yet another drawback, which is also present in dialysis tubing, is the potential loss of a sample due to osmotically driven water flux. As water goes into the sample compartment to balance the osmotic differential it causes the sample volume to increase, putting pressure on the dialysis membrane. Since the membranes allow fastest mass transfer when they are very thin, sometimes no more that 0.0003 inches thick, they are inherently weak. Thus, they can burst. To prevent this, the Pierce Slide-A-Lyzer® is available with thicker membranes. Unfortunately, this reduces the advantage of mass transfer speed obtained by the improved surface area to volume ratio.

U.S. application Ser. No. 09/833,616 discloses an invention that takes and entirely different approach to sample dialysis. It allows centrifugation of the dialysis compartment in order to maximize recovery of a sample that has been dialyzed. A variety of configurations are described which attempt to reduce sample handling. In prior art, a sample is removed from a container in which it resides, placed into the dialysis vessel, dialyzed, removed from the dialysis vessel, and returned to a storage container. The application discloses a dialysis membrane assembly that can be attached to the sample container, whereby dialysis can be performed without all of the sample handling steps typically used. However, a major drawback is the poor surface area to sample volume that results, limiting the speed of mass transfer. Thus, this disclosure is not helpful in resolving the surface area to volume ratio problems that are inherent to dialysis tubing.

In summary, U.S. Pat. No. 5,503,741 discloses a good basis for an improved apparatus for the dialysis of samples. The Slide-A-Lyzer® products referred to above provide a good alternative to dialysis tubing. However, there are shortcomings in terms of surface area to volume ratio, the required use of needles, the required orientation of the needle a manner that could cause injury to users or damage to the dialysis membrane, the need to attach secondary components to allow proper orientation in the dialysate solution, and the possibility of membrane damage from osmotic pressure differential. A device is needed that improves upon that disclosed by U.S. Pat. No. 5,503,741 and the Slide-A-Lyzer® products.

### SUMMARY OF THE PRESENT INVENTION

It is an object of the present invention to provide a device that can interface with standard laboratory pipettes for the introduction and removal of samples, integrate a high ratio of dialysis membrane surface area to sample volume size for improved mass transfer, automatically orient in a beneficial position when residing in dialysate solution, and prevent the potential for damage to the dialysis membrane from osmotic imbalance between the sample and the dialysate.

In one embodiment, the need for a gasket as a seal is eliminated, thereby creating an excellent surface area to volume ratio, and allowing access of the dialysis compartment by way of either a laboratory pipette or needle. If a user prefers to use a needle, the needle is oriented in a manner that reduces risk of needle injury to the user, and minimizes risk of needle damage to the dialysis membrane.

In another embodiment, a gasket is used for a seal, but is configured to allow the use of either a laboratory pipette or a needle in a manner to provide an improved surface area to volume ratio. If a user prefers to use a needle, the needle is oriented in a manner that reduces risk of needle injury to the user, and minimizes risk of needle damage to the dialysis membrane.

In another embodiment, the device is configured to automatically orient itself into a beneficial position for dialysis while being prevented from sinking to the bottom of the dialysate solution.

In another embodiment, the device is configured with a grid that protects the membrane from damage.

In another embodiment, the device controls pressure increases due to osmotic gradients by allowing a portion of the sample to move into a displacement compartment, thereby reducing pressure placed upon the delicate dialysis membranes.

### BRIEF DESCRIPTION OF THE DRAWINGS

FIG. 1A, FIG. 1B, FIG. 1C, and FIG. 1D are exploded, perspective views depicting an embodiment of the invention configured without a gasket to provide an improved surface area to volume ratio and allow fluid delivery and removal by pipette or needle. If fluid delivery and removal by needle is desired, the danger of needle stick or damage to the membranes is reduced.

FIG. 2A is a perspective view of the needle access disk of FIG. 1.

FIG. 2B is a top view of the disk.

FIG. 2C is a sectional view taken along the line A-A of FIG. 2B.

FIG. 2D is a sectional view taken along the line B-B of FIG. 2.

FIG. 2E is a bottom view of a needle access disk.

FIG. 3A, FIG. 3B, and FIG. 3C are sectional views depicting a pipette access port configured to allow fluid delivery and removal from the dialysis cartridge by using standard laboratory pipettes.

FIG. 4A and FIG. 4B are exploded, perspective views of an embodiment of the invention that utilizes a gasket.

FIG. 4C and FIG. 4D are fragmentary, perspective views of features enabling fluid to move into and out of the dialysis cartridge in directions that do not require the fluid handling equipment to be parallel to the dialysis membrane.

FIG. 5 is a perspective view of an embodiment of the invention configured with a grid to prevent distension of the dialysis membrane.

FIG. 6 is an elevational view of a dialysis cartridge positioned in a dialysate container.

FIG. 7A and FIG. 7B show an embodiment of the invention configured to relieve internal pressure.

### DETAILED DESCRIPTION OF THE INVENTION

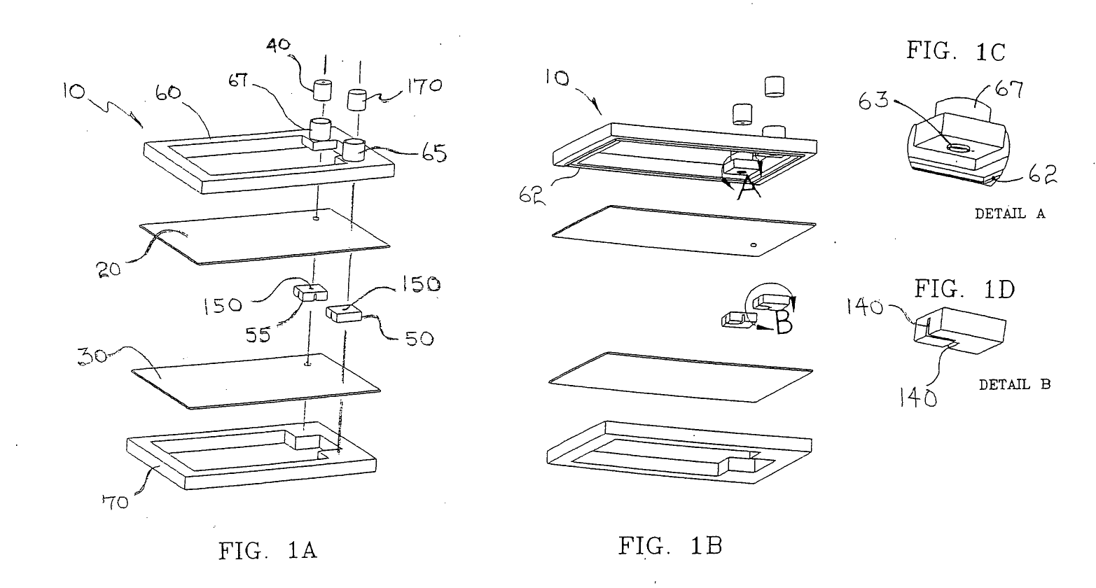

Exploded views of a preferred embodiment of dialysis cartridge 10 are depicted in FIG. 1A from an upper perspective, and FIG. 1B from a lower perspective. Needle access disk 50 and pipette access disk 55 reside between upper membrane 20 and lower membrane 30. Upper frame 60 and lower frame 70 sandwich upper membrane 20 and lower membrane 30 together about their perimeters, and at the upper surfaces of needle access disk 50 and pipette access disk 55, making a liquid tight compartment for sample. Perimeter sealing ridge 62, emanating from upper frame 60, presses against lower frame 70 in order to create a liquid tight seal about the perimeter of upper membrane 20 and lower membrane 30. Upper frame 60 contains needle access port holder 65, pipette access port holder 67, each with fluid transport opening sealing ridges 63, best shown in FIG. 1C which is Detail A of FIG. 1B. Fluid transport opening sealing ridges 63 apply the appropriate force against needle access disk 50 and pipette access disk 55 in order to seal upper membrane 20 about the perimeter of fluid transport opening 150 in a liquid tight manner. Needle access disk 50 and pipette access disk 55 integrate fluid movement slots 140, best shown in FIG. 1D which is Detail A of FIG. 1B. Fluid movement slots 140 allow fluid movement into and out of dialysis cartridge 10. In FIG. 1D, two fluid movement slots 140 are shown in needle access disk 50 and pipette access disk 55, but only one is required. Septum 170 resides in needle access port holder 65 in a manner such that a liquid tight seal is created between septum 170 and needle access port holder 65. Pipette access port 40 resides in pipette access port holder 67 in a manner such that a liquid tight seal is created between pipette access port 40 and pipette access port holder 67. Upper frame 60 and lower frame 70 can be designed to apply the appropriate squeeze by a variety of techniques such as sonic welding, mechanical fasteners, adhesives, and the like.

Upper membrane 20 and lower membrane 30 have a molecular weight cutoff (MWCO) that prohibits molecules and compounds larger than a predetermined size from escaping dialysis cartridge 10. In many applications, membrane MWCO will be less than 100,000 daltons, and often from 3,000 daltons to 30,000 daltons.

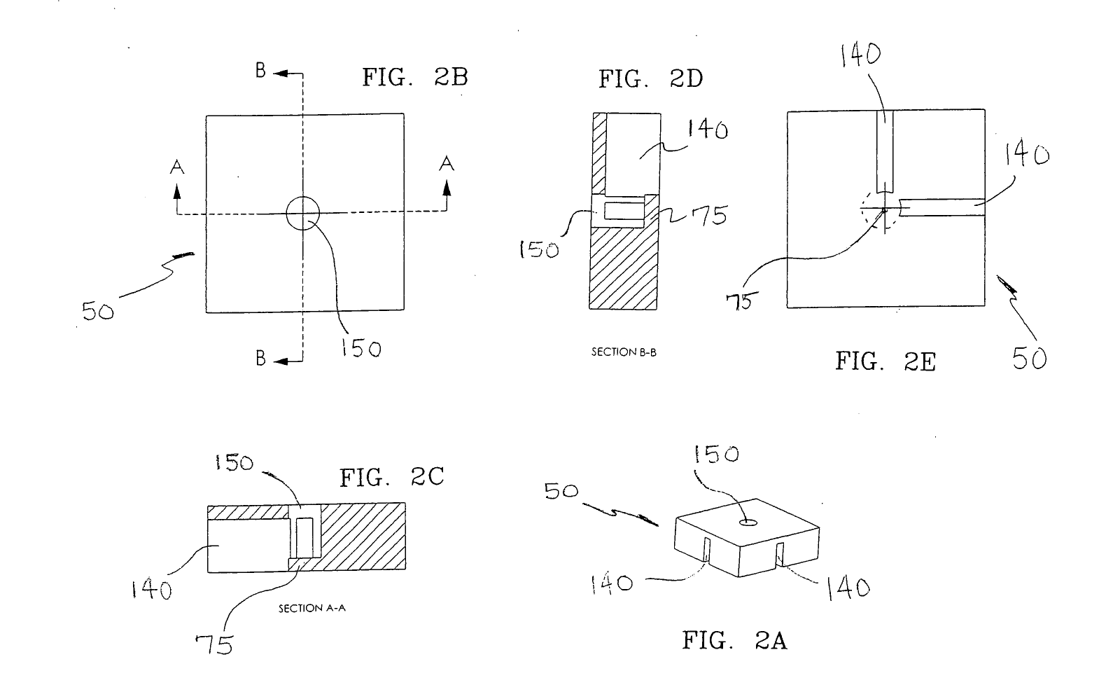

FIG. 2A shows a perspective view of needle access disk 50. FIG. 2B shows a top view of needle access disk 50. FIG. 2C shows section A-A of FIG. 2B, FIG. 2D shows section B-B of FIG. 2B, and FIG. 2E shows a bottom view of needle access disk 50. Needle access disk 50 should be comprised of a material with enough rigidity to ensure that it is able to provide adequate force to allow fluid transport opening sealing ridge 63 to seal upper membrane 20. Preferably, hardness should be about 60 Shore A or more. Fluid movement slot 140 is configured to be in communication with fluid transport opening 150. Fluid transport opening 150 is optional if needle access disk 50 is comprised of a compliant material that allows a needle to penetrate needle access disk 50, and make communication with fluid movement slot 140. In this case, those skilled in the art will recognize that needle access disk 50 should be comprised of a material that acts in a similar manner to a standard septum. When material choice precludes needle access disk 50 from acting as a septum, fluid transport opening 150 is required. An improved ratio of surface area to sample volume can be attained when needle access disk is of minimum profile. That allows upper membrane 20 and lower membrane 30 to be as close together as possible. Harder materials can allow a lower profile than soft materials. For example, material with hardness such as that of stainless steel, polycarbonate, polystyrene, polyethylene, or polypropylene are stiff enough so that fluid movement slot 140 will not collapse under the force of fluid transport opening sealing ridge 63. Soft materials can be used however, such as silicone or Kraton®. The softer the material, the easier it is for fluid movement slot 140 to collapse and stopping fluid flow under a given amount of force from fluid transport opening sealing ridge 63. For example, when material of about 60 Shore A is used, the depth of fluid movement slot 140 preferably should not exceed about 60% of the height of needle access disk 50. In this manner, adequate stiffness can be attained, which is needed to allow enough compressive force to seal upper membrane 20 against the upper surface of needle access disk 50, while fluid movement slot 140 remains open. A seal was attained using 60 Shore A material for needle access disk 50 and applying a force of 12 lb per linear inch of seal distance, when pipette access disk 50 was 0.082 inches in height and the fluid movement slot depth of was 0.047 inches. Fluid access slot width was 0.063 inches. Thus, the profile of pipette access disk 55 can be lower than that of needle access disk 50. The depth of fluid movement slot 140 can be reduced as more and more fluid movement slots are added to compensate for the loss of cross-sectional fluid flow area.

Needle puncture protector 75 is located below fluid transport opening 150 and above lower membrane 30. It acts to protect lower membrane 30 from puncture by a needle. Upper membrane 20 must have an opening aligned with fluid transport opening 150. The opening in upper membrane 20 can be made before or after the assembly is complete by puncture, burning (such as by use of a cauterizing tip), or cutting. It can also be created during use by puncture during needle access.

Pipette access disk 55 has similar design considerations as needle access disk 50 with the following exceptions. Needle puncture protector 75 is not needed for pipette access disk 55 as there is no danger of lower membrane 30 being damaged during pipetting. Also, fluid transport opening 150 is required.

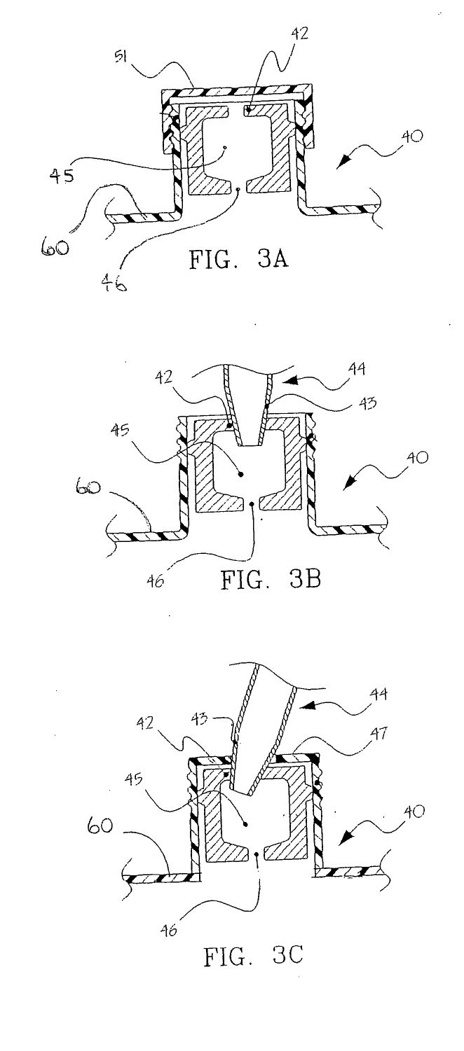

FIG. 3A, FIG. 3B, and FIG. 3C disclose configurations of an embodiment for pipette access in a liquid tight manner that allows the use of standard laboratory pipettes. Many of the concepts of this embodiment are discussed in co-pending U.S. application Ser. No. 10/460,850, the disclosure of which is incorporated by reference. This is a superior method of accessing the dialysis cartridge when compared to the use of needles. Risk of needle stick, risk of membrane damage, needle disposal, and the use of syringes is avoided. FIG. 3A shows a cross-sectional view of pipette access port 40. Pipette access port 40 is designed with an elastomeric thin walled access opening 42 capable of expanding in cross-section to create a seal with the tip of a pipette.

FIG. 3B shows pipette tip 43 inserted into thin walled access opening 42 of pipette access port 40. The cross-section of thin walled access opening 42 has increased relative to that of FIG. 3A in order to accommodate pipette tip 43. Thin walled access opening 42 applies a seal force to pipette tip 43. The thin-walled nature of the opening is a design characteristic intended to achieve a seal with less force exerted upon pipette tip 43 than the force exerted to retain pipette 44 in a vacuum pipettor. When the force required to break the seal between pipette 44 and thin walled access opening 42 does not exceed the force retaining pipette 44 in a vacuum pipettor, pipette 44 will be retained in the vacuum pipettor when it is withdrawn from the access port.

The force needed to dislodge the pipette from the pipettor can vary depending on the pipette, the pipettor, the amount of wear on the rubber piece in the pipettor that the pipette fits into, and how far the operator inserts the pipette into the pipettor. To assess the variance in force, a pipette was inserted into a pipettor with as little penetration into the pipettor as needed to attain a seal, and compared to a pipette inserted into the same pipettor as far it could go. Then the amount of force needed to dislodge the pipette from the pipettor was measured. When the pipette had minimal penetration into the pipettor, the force required to dislodge a 10 ml pipette (Fisherbrand® 13-678-11E) from a pipettor (Integra Biosciences Pipetteboy acu model) was measured at 0.2 lb. When the same pipette had maximum penetration, the force required to dislodge it from the pipettor was measured at 4.2 lb. The thickness and material characteristics of the thin walled access opening 42 will affect the force it applies to pipette 44. For example, tests have demonstrated that when the material thickness of the thin walled access opening is 0.02 inches, and the cross-section is circular with an opening diameter of 0.085 inches, and the material has a durometer of 60 Shore A, a pipette inserted to the maximum extent possible in a vacuum pipettor (Integra Biosciences Pipetteboy acu model) will remain in the vacuum pipettor when the tip is inserted and removed from thin-wall access opening 42. When the thin walled access opening 42 became wet, approximately 20% less resistance to pipette removal was encountered. Void volume 45 is designed such that it makes minimal contact with pipette tip 43 and allows pipette 44 to be inserted at, or rotated to, various angles. Preferably, the majority of gripping force applied to pipette tip 43 should occur from thin walled access opening 42 and not from contact with the walls enclosing void volume 45. Fluid access channel 46 allows unencumbered movement of fluid between the dialysis cartridge and pipette 44. In applications where a small sample volume is used, the volume of fluid access channel 46 can be reduced to minimize the volume of the sample that resides within it. For example, a 0.031 inch diameter, 0.5 inches long, will allow adequate flow while reducing the void volume. If void volume is not a concern, the cross-sectional area of access channel 46 can exceed that of thin walled access opening 42. If pipette tip 43 does enter fluid access channel 46, less gripping force will be exerted if fluid access channel 46 is a rigid material with a non-circular cross-sectional area, as contact area will be reduced.

FIG. 3C depicts pipette 44 traveling a fixed distance into pipette access port 40. Pipette stop 47 limits the amount of penetration that pipette 44 can make into pipette access port 40. The opening of pipette stop 47 should be preferably dimensioned such that when pipette tip 43 resides within void volume 45 during fluid handling, and a seal exists between pipette 44 and thin walled access opening 42, pipette 44 is prevented from moving further into pipette access port 40. When pipette stop 47 is present, and dimensioned in the preferred manner, pipette tip 43 cannot make contact with fluid access channel 46 or the walls of void volume 45. Fluid access channel 46 and void volume 45 will then have no effect on the removal force and can have any type of cross-sectional geometry that allows adequate fluid movement.

As best shown in FIG. 3C if pipette stop 47 is configured with a dimension slightly larger than the dimension of thin walled access opening 42, it can still limit penetration into void volume 45, but allow pipette 44 to be docked into pipette access port 40 without the need to be perpendicular. This can simplify liquid handling when pipette stop 47 is used because the pipette can be at a variety of angles that may be more ergonomically appealing. As an example, a dimensional opening of pipette stop 47 that is about 0.010 inches in diameter larger than that of thin walled access opening 42 can allow a range of pipette positions that do not breach the seal of thin walled access opening 42 when interfacing with a 25 ml VWR pipette (catalogue number 53283-710) that is about 12 inches long.

When pipette access port 40 is not in use, a cap, plug, or any other method of preventing fluid movement through it should be utilized in order to ensure that sample volume does not leave, and/or dialysate does not enter, the dialysis cartridge. This will also prevent contaminants from entering the dialysis cartridge. FIG. 3A shows the use of cap 51.

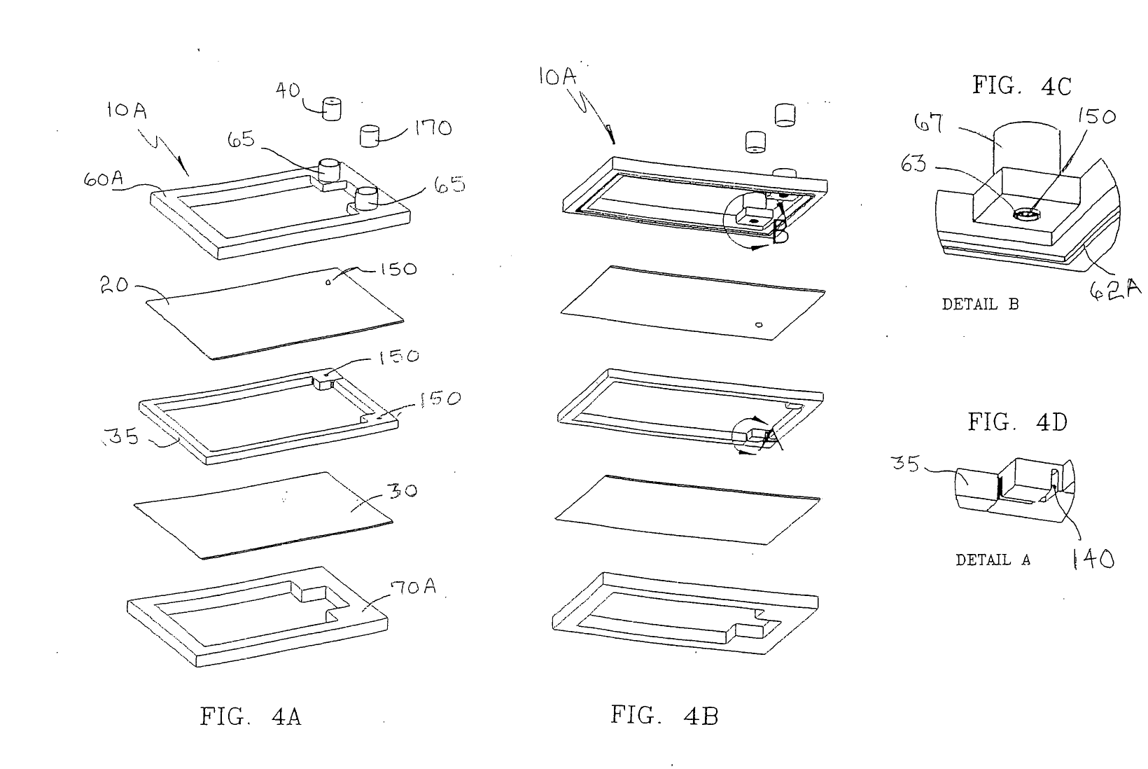

FIG. 4A and FIG. 4B show exploded views of a preferred embodiment of a dialysis cartridge that, like U.S. Pat. No. 5,503,741 utilizes a gasket, but unlike U.S. Pat. No. 5,503,741 allows a higher surface area to volume ratio, allows the optional use of needles in a manner that minimizes risk of injury or damage to the membrane, and can be configured so that fluid can be added and removed by a pipette. This configuration depicted allows the option of pipette or needle access. However, it will be understood from the description that access by just a needle or access by just a pipette can be an option. Dialysis cartridge 10A integrates gasket 35. Gasket 35 design characteristics in the section or sections where fluid moves through it are similar as those described previously for the needle access disk and the pipette access disk. Also, as previously described for the needle access disk, fluid transport opening 150 is optional when a needle is used for access. Gasket 35 resides between upper membrane 20 and lower membrane 30 and provides a seat for perimeter sealing ridge 62A, which emanate from upper frame 60A and lower frame 70A. Gasket 35 is configured to allow fluid to move into and out of it. As best depicted in FIG. 4C, sealing ridges 62A, emanating from upper frame 60, encircles fluid transport opening 150. Fluid transport opening 150 is in communication with fluid movement slots 140, best depicted in FIG. 4D, to allow fluid to enter and exit dialysis cartridge 10A. In the event a needle is used for fluid handling, gasket 35 integrates needle puncture protector 75, as previously described, which prevents damage to lower membrane 30. In the event a pipette is used for fluid handling, a needle puncture protector is not needed at the base of fluid transport opening 150, as a pipette cannot damage lower membrane 30.

Unlike traditional gasket seals, gasket 35 has a slot that passes under the seal between gasket 35 and upper membrane 20. Fluid transport opening sealing ridge 63 digs into upper membrane 20 about the perimeter of fluid transport opening 150, and compresses upper membrane 20 against gasket 35 in order to create a liquid tight seal. Since fluid movement slots 140 undercut the seal area, care must be given to ensure that that gasket 35 can still exert enough force against fluid transport opening sealing ridge 63 when in compression, to ensure liquid loss does not occur. It is desirable to minimize the thickness of gasket 35 in order to provide the best surface area to volume ratio of the sample. Material must be such that the sample being dialyzed does not move directly through the gasket. For seal design, fluid flow, and profile definition, material consideration is similar to that described previously for needle access disk 50 and pipette access disk 55. As an example of an acceptable design configuration, a liquid tight seal was created that allowed adequate fluid flow when the frame applied a compressive force of 12 pounds per linear inch of seal contact upon an 8 micron thick regenerated cellulose membrane pressed against a gasket comprised of about 70 Shore A material. The initial thickness of the gasket prior to applying the force was 0.082 inches and the fluid access slot penetrated into the gasket to a depth of 0.047 inches. Fluid access slot width was 0.063 inches. The depth of penetration of the sealing ridge of the frame was about 0.010 inches per side and the contact width was approximately 0.02 inches. Trial and error is suggested as other geometries and materials are evaluated. Material stiffness, flatness, surface finish, the profile of fluid transport opening sealing ridge 63, and the thickness of upper membrane 20 and lower membrane 30 are among the factors that impact seal integrity.

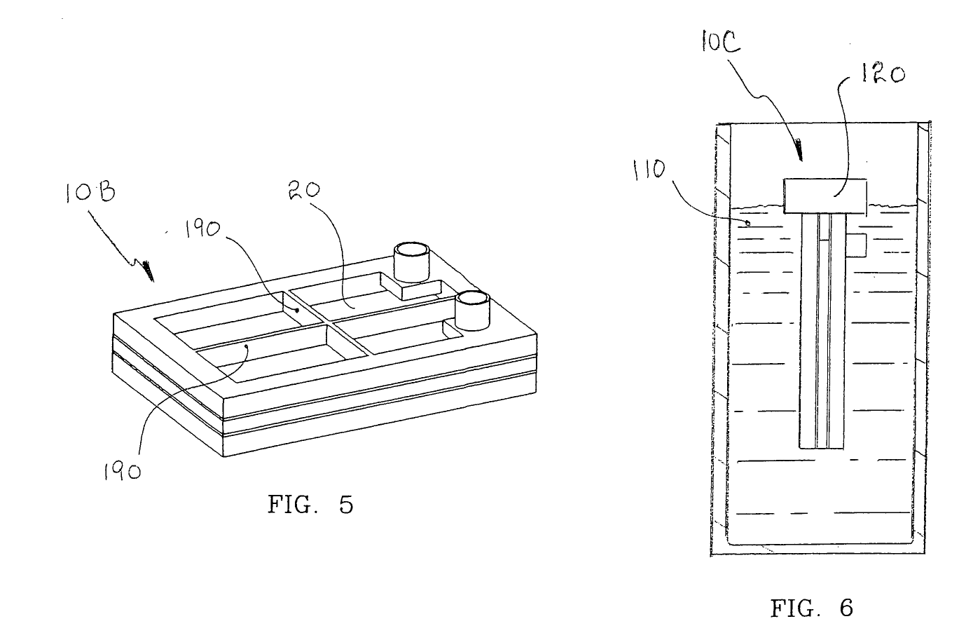

FIG. 5 depicts an embodiment of a dialysis cartridge configured to constrain the membranes in a relatively planar position, adding further control over the surface area to volume ratio. Dialysis cartridge 10B integrates grid 190, which acts to prevent the membranes from bulging due to the weight of the sample, control the increase of sample volume that can occur due to osmotically driven absorption of water, and help protect the membranes from stir bar damage. Grid 190 should preferably be dimensioned to make contact with upper membrane 20 and lower membrane 30 in a manner that allows maximum exposure of the membranes to dialysate solution. Thus, grid 190 should have a very small cross-sectional dimension in the direction parallel to the membranes. Those skilled in the art will recognize that the strength of the grid can best be increased by increasing its cross-sectional area in the direction perpendicular to the membrane as opposed to the parallel direction, to avoid diminishing the useful membrane area for mass transfer.

FIG. 6 depicts an embodiment in which the dialysis cartridge is automatically oriented in the dialysate such that it cannot sink to the bottom of the dialysate container. Bouyant feature 120 acts to orient dialysis cartridge 10C in a vertical position and prevent it from sinking in dialysate 110. Bouyant feature 120 can be filled with air or any material that has a density less than that of dialysate 110. The size of buoyant feature 120 must be large enough that weight of the displaced dialysate 110 is greater than the weight of dialysis cartridge 10C.

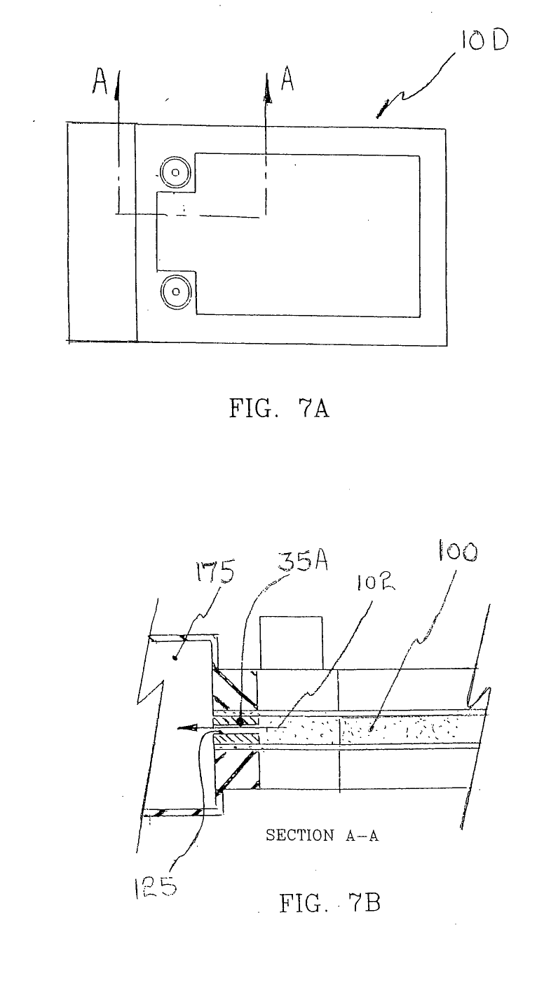

FIG. 7A and FIG. 7B depict an embodiment that prevents pressurization of the sample compartment that may occur as osmotic pressure differential between the sample and the dialysate draws water from the dialysate into the sample compartment. FIG. 7A depicts a top view of dialysis cartridge 10D. FIG. 7B depicts section A-A of FIG. 7A. If too much pressure differential exists, and the membranes distend substantially, there is a possibility that the membranes can break. As shown in FIG. 7B, dialysis cartridge 10D is configured to avoid that outcome by allowing the sample to travel into displacement feature 175 by way of check valve 125 formed in gasket 35A. In this embodiment, check valve 125 is a hole traversing the wall of gasket 35. The cross-sectional area of the hole is small enough to prevent travel of the sample under normal pressure, due to the effects of capillary resistance. However, under elevated pressure, sample 100 is driven through the hole and into displacement feature 175 as indicated by directional arrow 102. As sample volume is displaced into displacement feature 175, the pressure is reduced and flow ceases. Recovery of any sample material that comes to reside in displacement feature 175 can be done by creating a port to displacement feature 175, or applying the appropriate amount of vacuum by way of either the needle access port or pipette access port. If the check valve is configured as a hole through the gasket, the hole diameter can be sized based on desired pressure limits by trial and error. For example, about 2 inches of water will not drive water through a hole of 0.031 inches in diameter when the hole is about 0.04 in length or greater. Those skilled in the art will recognize that check valve 125 can be configured in any number of ways, including duck bill check valves, poppet valves, and the like.

Those skilled in the art will recognize that numerous modifications can be made thereof without departing from the spirit. Therefore, it is not intended to limit the breadth of the invention to the embodiments illustrated and described. Rather, the scope of the invention is to be interpreted by the appended claims and their equivalents. Each publication, patent, patent application, and reference cited herein is hereby incorporated herein by reference.

1. A device for the dialysis of a sample comprising a liquid tight sealed vacant chamber formed by a gasket with dialysis membranes disposed on each side of said gasket without any additional supporting structure there between, an upper frame, a lower frame, at least one access port, said gasket also having at least one fluid movement slot.

2. The device of claim 1 where said access port is appropriately configured to allow fluid to be added or removed from said device with a needle by way of a septum and gasket fluid movement slot.

3. The device of claim 1 where said access port is appropriately configured to allow fluid to be added or removed from said device with a pipette by way of a pipette access port, a fluid access opening, and fluid movement slot.

4. The device of claim 1, including a grid.

5. The device of claim 1, including a buoyant feature.

6. The device of claim 5, including a check valve for the purpose of allowing sample volume to move through it if sample volume pressure is elevated beyond a predetermined pressure.

7. A device for the dialysis of a sample comprising a liquid tight sealed vacant chamber formed by an upper frame and a lower frame acting to seal two dialysis membranes disposed one above the other, at least one access disk residing between said membranes, wherein said access disk is either a needle access disk or a pipette access disk.

8. The device of claim 7, including a grid.

9. The device of claim 7, including a buoyant feature.

10. The device of claim 7, including a check valve for the purpose of allowing sample volume to move through it if sample volume pressure is elevated beyond a predetermined pressure.
